(19) United States
(12) Patent Application Publication
(10) Pub. No.: US 2025/0242878 A1
(43) Pub. Date: Jul. 31, 2025

(54) Water Bottle Mount Assembly

(71) Applicant: MSNS, LLC, Morgan Hill, CA (US)

(72) Inventor: Neal Saiki, Santa Cruz, CA (US)

(21) Appl. No.: 19/037,160

(22) Filed: Jan. 25, 2025

Related U.S. Application Data
(60) Provisional application No. 63/624,798, filed on Jan. 25, 2024.

(51) Int. Cl. B62J 11/04

(52) U.S. Cl. CPC B62J 11/04

(57) ABSTRACT

A water bottle mount and water bottle mount assembly configured to mount onto a head tube of a bicycle. The water bottle mount assembly may have a right side bottle cage and a left side bottle cage which are adapted to receive water bottles. The water bottle mount is adapted to mount onto a traditional bicycle head tube, or fork within a head tube, such that additional mounting points and additional mounting hardware are not needed.

### CROSS-REFERENCE TO RELATED APPLICATIONS

This application claims priority to U.S. Provisional Patent Application No. 63/624,798 to Saiki, filed Jan. 25, 2024, which is hereby incorporated by reference in its entirety.

### FIELD OF THE INVENTION

This invention relates to bicycling, namely a water bottle mount assembly adapted for mounting to a head tube of a bicycle.

### BRIEF DESCRIPTION OF THE DRAWINGS

FIG. 1 is a view of a water bottle mount assembly mounted on a head tube of a bicycle according to some embodiments of the present invention.

FIG. 2 is an exploded view of a water bottle mount assembly according to some embodiments of the present invention.

FIG. 3A is a view of a water bottle mount according to some embodiments of the present invention.

FIG. 3B is a view of a water bottle mount according to some embodiments of the present invention.

FIG. 4 is a cutaway view of a water bottle mount according to some embodiments of the present invention.

FIGS. 5A-D are views of a water bottle mount according to some embodiments of the present invention.

FIG. 6 is a view of a water bottle mount assembly on a head tube and fork according to some embodiments of the present invention.

### SUMMARY

A water bottle mount and water bottle mount assembly configured to mount onto a head tube of a bicycle. The water bottle mount assembly may have a right side bottle cage and a left side bottle cage which are adapted to receive water bottles. The water bottle mount is adapted to mount onto a traditional bicycle head tube, or fork within a head tube, such that additional mounting points and additional mounting hardware are not needed.

### DETAILED DESCRIPTION

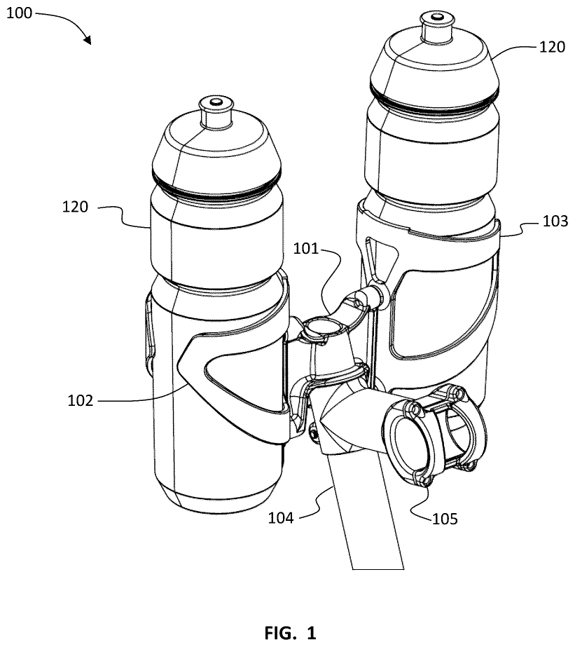

In some embodiments of the present invention, as seen in FIG. 1, a water bottle mount assembly 100 is configured to mount to a conventional bicycle head tube 104 above the stem 105. The water bottle mount assembly 100 has a water bottle mount 101 coupled to a right side bottle cage 102 and a left side bottle cage 103. The right side bottle cage 102 and a left side bottle cage 103 are adapted to support and retain water bottles 120, which may be of a standard configuration, in some aspects.

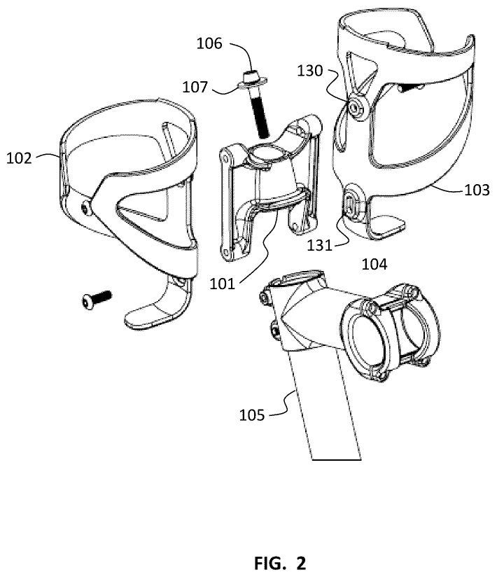

FIG. 2 illustrates an exploded view of the water bottle mount assembly 100 according to some embodiments of the present invention. A water bottle mount body 101 is configured to couple to the head tube 105 above the stem 104. A bolt 106 with washer 107 resides within an annular recess withing the water bottle mount body 101 and through a central hole at the bottom of the annular recess, as discussed further below. A right side bottle cage 102 and a left side bottle cage 103 are configured to attach to the water bottle mount body 101. The bottle cages have an upper mounting hole 130 and a lower mounting hole, or slot, 131, to allow for the coupling of the bottle cages to the water bottle mount body with the use of threaded fasteners.

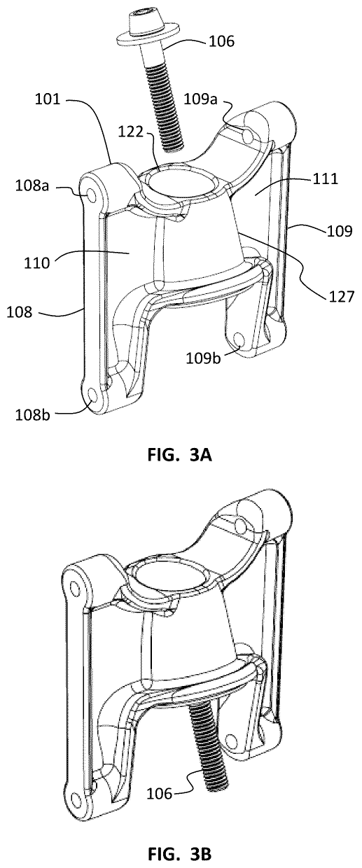

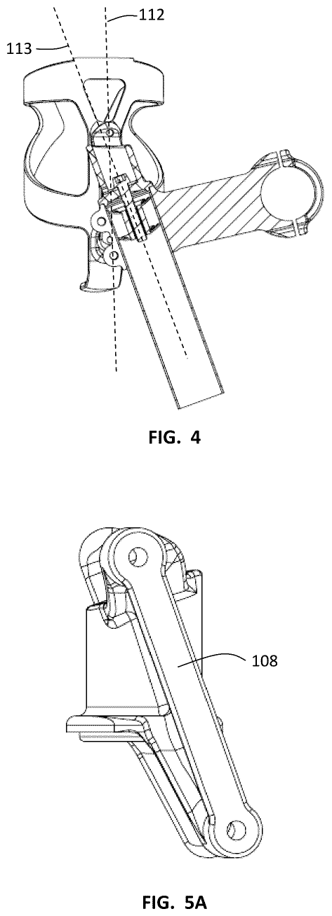

FIGS. 3A and 3B illustrate the water bottle mount body 101 according to some embodiments of the present invention. A central section 127 has an annular recess 122 adapted to receive a bolt 106, as discussed further below. A right side connecting structure 110 is coupled to the central section 127. A right side cage mounting surface 108 is at an outer end of the right side connecting structure. The right side cage mounting surface 108 may be planar in some aspects. In some aspects, the right side cage mounting surface 108 may present as a plane only at the upper and lower ends. A right side upper fastening feature 108a resides at an upper end of the right side cage mounting surface 108, and a right side lower fastening feature 108b resides at a lower end of the right side cage mounting surface. A left side connecting structure 111 is coupled to the central section 127. A left side cage mounting surface 109 is at an outer end of the left side connecting structure. The left side cage mounting surface 109 may be planar in some aspects. In some aspects, the left side cage mounting surface 109 may present as a plane only at the upper and lower ends. A left side upper fastening feature 109a resides at an upper end of the left side cage mounting surface 109, and a left side lower fastening feature 109b resides at a lower end of the left side cage mounting surface. In some aspects, the fastening features may be threaded insert. In some aspects, the fastening features may be threaded posts. In some aspects, the fastening features may be magnetic couplers.

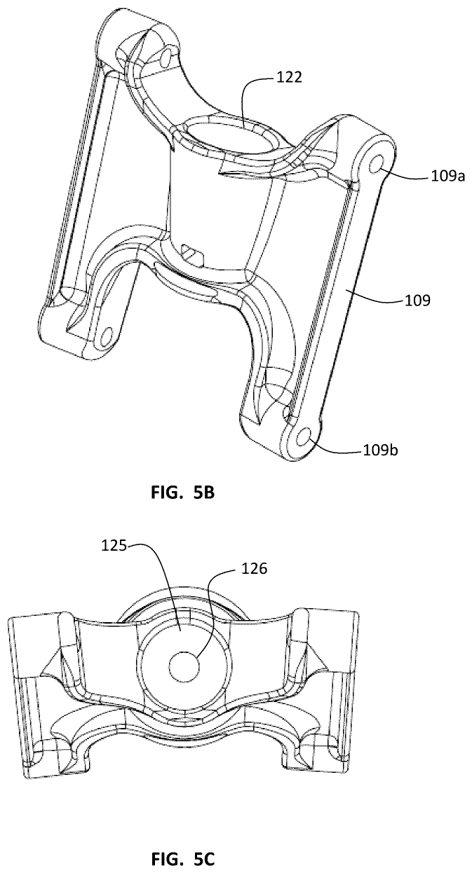

FIG. 4 illustrates a cross-sectional view of the water bottle mount assembly 100 mounted onto a bicycle head tube, which may be mounting within a fork which resides within the head tube of the bicycle. A first axis 112 is defined as an axis through the centers of the upper fastening feature and the lower fastening feature on the cage mounting surfaces. A second axis 113 is defined as the axis of the mounting bolt 106, which will be perpendicular to the bottom mounting surface of the water bottle mount body 101 at its attaching surface to the head tube 105. In some aspects, the angle between the first axis 112 and the second axis 113 is 20 degrees. In some aspects, the angle between the first axis and the second axis is in the range of 15-25 degrees. In some aspects, the angle between the first axis and the second axis is in the range of 10-30 degrees. The offset angle may allow for the water bottles mounted into the cages of the water bottle mount assembly 100 to be vertical when in use on a bicycle.

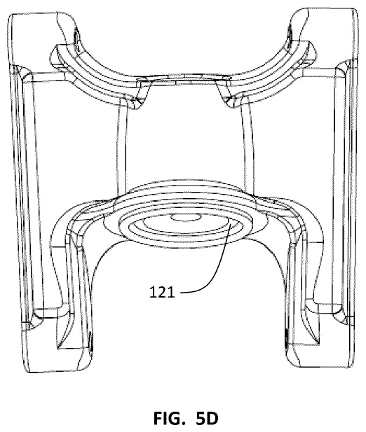

FIGS. 5A-D illustrate further views of the water bottle mount body 101 according to some embodiments of the present invention. The annular recess 122 may have a bottom 125 with a central mounting hole 126 configured to allow for the pass through of the mounting bolt 106 to the fork within the head tube. The mounting bolt 106 may attach using a standard attachment as would be seen on a bicycle. In some aspects the central hole may be approximately 6 mm in diameter. In some aspects, the central hole may have a diameter in the range of 5-6 mm. The bottom 125 may have a planar bottom mounting surface.

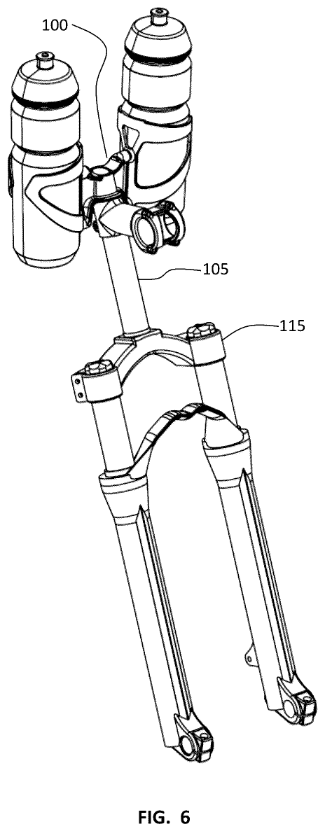

FIG. 6 illustrates a water bottle mount assembly 100 as mounted onto the upper tube 105 of a fork assembly 115.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

What is claimed is:

1. A water bottle mount assembly, said water bottle mount assembly comprising:
a water bottle mount body, said water body mount body comprising:
a central section, said central section comprising a mounting surface on a bottom portion of the water bottle mount, said mounting surface defining a first plane, and a mounting hole perpendicular to said first plane;
a right side connecting structure coupled to said central section, said right side connection structure comprising:
a right side bottle cage mounting surface; and
an upper fastening feature at an upper end of said right side bottle cage mounting surface; and
a lower fastening feature at a lower end of said right side bottle cage mounting surface; and
a left side connecting structure coupled to said central section, said left side connection structure comprising:
a left side bottle cage mounting surface; and
an upper fastening feature at an upper end of said left side bottle cage mounting surface; and
a lower fastening feature at a lower end of said right side bottle cage mounting surface.

2. The water bottle mount assembly of claim 1 further comprising:
a right side bottle cage coupled to said right side bottle cage mounting surface; and
a left side bottle cage coupled to said left side bottle cage mounting surface.

3. The water bottle mount assembly of claim 2 wherein said right side bottle cage and said left side bottle cage comprise an upper and a lower through hole, and wherein said upper and lower fastening features of said right side and left side connecting structures are threaded receivers, and wherein said water mount assembly further comprises threaded fasteners coupling said right side bottle cage and said left bottle cage through said upper and lower through holes to said right side connecting structure and said left side connecting structure.

4. The water bottle mount assembly of claim 1 wherein a line through a center said upper fastening feature of said right side connecting structure and a center of said lower fastening feature and parallel to said right side bottle cage mounting surface defines a first axis, and wherein a line perpendicular to said first plane defines a second axis, and wherein said first axis and said second axis are offset at an angle in the range of 15-25 degrees.

5. The water bottle mount assembly of claim 3 wherein a line through a center said upper fastening feature of said right side connecting structure and a center of said lower fastening feature and parallel to said right side bottle cage mounting surface defines a first axis, and wherein a line perpendicular to said first plane defines a second axis, and wherein said first axis and said second axis are offset at an angle in the range of 15-25 degrees.

6. The water bottle mount assembly of claim 1 wherein a line through a center said upper fastening feature of said right side connecting structure and a center of said lower fastening feature and parallel to said right side bottle cage mounting surface defines a first axis, and wherein a line perpendicular to said first plane defines a second axis, and wherein said first axis and said second axis are offset at an angle in the range of 10-30 degrees.

7. The water bottle mount assembly of claim 3 wherein a line through a center said upper fastening feature of said right side connecting structure and a center of said lower fastening feature and parallel to said right side bottle cage mounting surface defines a first axis, and wherein a line perpendicular to said first plane defines a second axis, and wherein said first axis and said second axis are offset at an angle in the range of 10-30 degrees.

8. The water bottle mount assembly of claim 1 wherein said mounting hole is in the range of 5-6.5 mm.

9. The water bottle mount assembly of claim 2 wherein said mounting hole is in the range of 5-6.5 mm.

10. The water bottle mount assembly of claim 1 wherein said mounting hole is in the range of 5-6.0 mm.
